(19) United States
(12) Patent Application Publication
(10) Pub. No.: US 2026/0072750 A1
(43) Pub. Date: Mar. 12, 2026

(54) ALLOCATING SYSTEM RESOURCES

(71) Applicant: Meta Platforms Technologies, LLC, Menlo Park, CA (US)

(72) Inventors: Satyajeet Singh Ahuja, Saratoga, CA (US); Kevin Jerome Quirk, New York, NY (US); James Williams, Raleigh, NC (US); Mikel Jimenez Fernandez, Palmetto Bay, FL (US); Petr Lapukhov, New York, NY (US)

(73) Assignee: Meta Platforms Technologies, LLC, Menlo Park, CA (US)

(21) Appl. No.: 19/326,033

(22) Filed: Sep. 11, 2025

Related U.S. Application Data
(60) Provisional application No. 63/694,115, filed on Sep. 12, 2024.

(51) Int. Cl. G06F 9/50

(52) U.S. Cl. CPC G06F 9/5033

(57) ABSTRACT

As disclosed herein, a computer-implemented method for allocating system resources is provided. The computer-implemented method may include determining an initial subset of a first set of system resources for performing a task. The computer-implemented method may include defining a target runtime for performing the task. The computer-implemented method may include determining, based on the target runtime, a first additional subset of the first set of system resources required for performing the task and a second additional subset of a second set of system resources required for performing the task. The computer-implemented method may include determining whether the first additional subset or the second additional subset includes fewer system resources. The computer-implemented method may include allocating the first or the second additional subset for the task based on the first or the second additional subset including fewer system resources. A system and a non-transitory computer-readable storage medium are also disclosed.

### BACKGROUND

### Field

The present disclosure relates to methods for accommodating system resource shortages or failures by allocating and utilizing spare system resources.

### Related Art

Sparing may refer to strategies for managing or optimizing system resources to ensure that computational tasks, such as model training jobs, may continue without interruption in the event of a system resource shortage or failure. In the event of a system resource shortage or failure, spare system resources may take over the task to ensure that there is no interruption in the performing of the task.

### SUMMARY

The subject disclosure provides for systems and methods for allocating system resources for performing a task (e.g., training an artificial intelligence (AI) model).

According to certain aspects of the present disclosure, a computer-implemented method is provided. The computer-implemented method may include determining an initial subset of a first set of system resources for performing a task. The computer-implemented method may include defining a target runtime for performing the task. The computer-implemented method may include determining, based on the target runtime, a first additional subset of the first set of system resources required for performing the task and a second additional subset of a second set of system resources required for performing the task. The computer-implemented method may include determining whether the first additional subset or the second additional subset includes fewer system resources. The computer-implemented method may include allocating the first or the second additional subset for the task based on the first or the second additional subset including fewer system resources.

According to another aspect of the present disclosure, a system is provided. The system may include one or more processors. The system may include a memory storing instructions that, when executed by the one or more processors, cause the system to perform operations. The operations may include determining an initial subset of a first set of system resources for performing a task. The operations may include defining a target runtime for performing the task. The operations may include determining, based on the target runtime, a first additional subset of the first set of system resources required for performing the task and a second additional subset of a second set of system resources required for performing the task. The operations may include determining whether the first additional subset or the second additional subset includes fewer system resources. The operations may include allocating the first or the second additional subset for the task based on the first or the second additional subset including fewer system resources.

According to yet other aspects of the present disclosure, a non-transitory computer-readable storage medium storing instructions encoded thereon that, when executed by a processor, cause the processor to perform operations, is provided. The operations may include determining an initial subset of a first set of system resources for performing a task. The first set of system resources may include a first plurality of graphics processing units (GPUs), and the task may include training an artificial intelligence (AI) model. The operations may include defining a target runtime for performing the task. The operations may include determining a maintenance metric for at least one of the first set of system resources and a second set of system resources. The operations may include determining, based on the target runtime and the maintenance metric, a first additional subset of the first set of system resources required for performing the task when the initial subset of system resources is exhausted. The operations may include determining, based on the target runtime and the maintenance metric, a second additional subset of the second set of system resources required for performing the task when the initial subset of system resources is exhausted. The second set of system resources may include a second plurality of graphics processing units (GPUs). The operations may include determining whether the first additional subset or the second additional subset includes fewer system resources. The operations may include allocating the first additional subset or the second additional subset for the task based on the first additional subset or the second additional subset including fewer system resources.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example environment suitable for allocating system resources, according to some embodiments;

FIG. 2 is a block diagram illustrating details of an example client device and an example server from the environment of FIG. 1, according to some embodiments;

FIG. 3 includes a chart illustrating an example curve representing the relationship between job size and job duration where inter-pod sparing and intra-pod sparing use an equal number of spare system resources, according to some embodiments;

FIG. 4 is a table showing the percentage of sparing required to meet the target job mean-time-to-failure (MTTF) for a collection of job sizes and durations as illustrated in FIG. 3, according to some embodiments;

FIG. 5 is a flowchart illustrating operations in a method for allocating system resources, according to some embodiments;

FIG. 6 is a block diagram illustrating an exemplary computer system with which client devices and the method in FIG. 5 may be implemented, according to some embodiments.

Appendixes A, B, and C, which are incorporated herein by reference, include drawings, examples, and/or other disclosures which provide details and further understanding of various aspects of the subject technology.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive. Those skilled in the art may realize other elements that, although not specifically described herein, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### General Overview

Sparing may refer to strategies for managing or optimizing system resources to ensure that computational tasks, such as model training jobs, may continue without interruption in the event of a system resource shortage or failure. In the event of a system resource shortage or failure, spare system resources may take over the task to ensure that there is no interruption in the performing of the task.

As used herein, a pod may include a collection of system resources (e.g., central processing units (CPUs), graphics processing units (GPUs), memory, hard drive storage, network bandwidth, battery). By way of nonlimiting example, a pod may include a collection of GPUs connected by a network (e.g., a fast private network).

As disclosed herein, novel systems and methods represent a significant advancement in the field of system resource management by determining under what conditions inter-pod or intra-pod sparing uses fewer spare system resources (e.g., GPUs) to ensure a job completes without running out of system resources.

In an exemplary embodiment, a model training job may require M pods for a certain amount of time. Each pod may contribute N system resources (e.g., GPUs) to the workload. Therefore, the “shape” of the workload may be MxN system resources. Given a job size of MxN GPUs, an expected job runtime of T, and a target mean-time-to-failure MTTF to ensure a high success probability to complete the run, it may be determined whether intra-pod or inter-pod sparing uses fewer spare GPUs (e.g., idle system resources). By way of non-limiting example, given a pod size of 72 GPUs, with 64 of the 72 GPUs required by the job, 8 of the 72 GPUs may be allocated as spares (i.e., intra-pod spares); or given a pod size of 72 GPUs, with 64 of the 72 GPUs required by the job, one or more GPUs from M other pods (i.e., inter-pod spares) may be allocated to the job.

As described herein, inter-pod sparing may the more efficient sparing technique for large training jobs and for jobs of short-duration where no sparing is needed. As the job size increases, inter-pod sparing may benefit from the following: (1) For the same percentage of sparing, larger jobs may have a longer spares queue that offsets the higher failure rates from job-level protection than the smaller pod-level protection failure rates that drive the intra-pod sparing queues. (2) The amount of sparing may be tuned more precisely than intra-pod sparing, which may be limited to jumps of one on the number of GPU blades contributing to a job in a rack (e.g. 6.25%, 12.5%, etc.).

As described herein, intra-pod sparing may be more efficient for small (less than 2 K, where K is the number of GPU blades), long-duration (more than one day) jobs and for medium, long-duration jobs when its fixed 6.25% or 12.5% sparing closely matches the requirement. This is due to the following: (1) For small jobs, adding a spare pod is a large percentage of sparing compared to adding a spare GPU blade favoring intra-pod sparing. (2) For medium-size, multiday jobs that require around 6.25% or 12.5% sparing, inter-pod sparing only has marginal gains from the longer queue and finer quantization, giving intra-pod sparing the advantage. However, the advantage may diminish as the job size grows.

As described herein, where inter-pod is superior, the relative gain of inter-pod grows with job size. Where intra-pod is superior, the relative gain of intra-pod decreases with job size. The percentage of sparing required with job-level protection may be significantly lower (e.g., two times lower) than dedicated pod-level protection for large jobs.

As described herein, intra-pod sparing may require hot-swappable GPU blade hardware and live repair operations (other blades may be unaffected during repair) and the trade-off between the techniques may be sensitive to the GPU blade failure rate with higher failure rates favoring intra-pod sparing.

As described herein, while the same spare may not be assigned to two jobs, in the case of inter-pod sparing, the same spare may be used opportunistically by low-priority jobs that may be evicted. Intra-pod spare GPUs may rarely be used under steady state.

To compare the efficacy of inter-pod and intra-pod sparing, the set of job sizes and durations under which one strategy outperforms the other may be determined. A job may be denominated in terms of both the number of GPUs the job requires, given in terms of pods, and the expected duration of the job. In order to avoid a job becoming stranded due to lack of GPUs in the event of a failure, spare GPUs may be kept in reserve for each job. The amount of spares may be dependent on the sparing method (i.e., intra-pod or inter-pod) and a target probability of the job completing without needing additional resources beyond the reserved spares. Sparing may be lowering resource utilization (i.e., reserved idle GPUs) in order to ensure jobs do not become blocked.

To determine the efficacy of the two sparing options for a given job size in pods M, job duration T, and target success probability a, the following steps may be taken:
(i) Determine a job mean-time-to-failure MTTF target based on the job duration to ensure a high success probability (i.e., completing the job without running out of resources).
(ii) Solve for the amount of additional GPU blades per rack P required for intra-pod sparing and the amount of additional pods R required for inter-pod to meet the job MTTF target.
(iii) Calculate the percentage of GPUs allocated to spares for each method and pick the method with the smaller percentage.

For the analysis described herein, the following may be assumed:
(i) A pod may be composed of two racks, each contributing K GPU blades to the workload.
(ii) Intra-Pod sparing adds P additional standby GPU blades to each rack.
(iii) Inter-Pod sparing adds R additional standby pods that can be used by the workload.
(iv) The GPU blade may dominate the failure profile of a rack. Only GPU blade reliability may be considered. Other component failures may not be considered.
(v) Hot swapping of devices may allow live repairs to be made while the other blades in a rack are operational.
(vi) The conditional repair rate may be constant for all devices (e.g., GPU blade, rack, pod).
(vii) All devices and operational modes may have a constant conditional failure rate. The devices may be in their “useful life” period beyond any of the initial early failures or end-of-life failures.
(viii) All failures or outages may be independent.
(ix) Powered-on spares may fail while in standby whereas powered-off spares may not fail while in standby.
(x) The failure rate of switching to a spare is zero. However, it may result in the job retreading to the last checkpoint, thereby wasting the compute resources.

A job requiring M pods with a job duration T has a mean-time-to-failure MTTF target of

$$M T T {F}_{j o b} = 10 \cdot T \qquad ( 1 )$$

This target may be chosen to ensure a high success rate. If the distribution of the job failure time was known, a target providing a specific success rate could be set.

For inter-pod MTTF, consider a workload of M operational pods, where each pod has two racks and each rack contributes K GPU blades. The failure of any of the K blades in the rack halts the job on the rack as it can no longer contribute K GPUs and removes the corresponding pod from the pool of operational and spare pods assigned to the job until it can be repaired. If the pool shrinks below the job requirement, then the job is halted.

To determine the MTTF, this may be modeled as a single queue containing the failed pods. As pods fail, the pods are added to the queue; as pods are repaired, the pods are removed from the queue. If the queue length exceeds the number of spares, then there are insufficient resources, and the job stops. From Appendix B, the MTTF of the inter-pod scheme with R spare powered on pods may be

$$M T T {F}_{inter - p o d} = \frac{M T T {F}_{D}}{2 \cdot K} {\sum }_{k = 0}^{R} {\sum }_{m = 0}^{R - k} \frac{{( \frac{γ}{2 K} )}^{k} {\prod }_{n = 1}^{k} ( m + n )}{{\prod }_{n = 0}^{k} ( M + R - ( m + n ) )} \qquad ( 2 )$$

$$where$$

$$γ {=}^{Δ} \frac{MTT {F}_{D}}{MTTR}$$

is the ratio of the mean GPU blade failure time to the mean repair time. The failure rate driving the queue expansion is that of the composite failure rate of GPU blades in the job which can be seen in (2) by the attenuation by powers of 2·M·K, the number of GPU blades in the job.

For intra-pod MTTF, consider a workload of M operational pods, where each pod has two racks and each rack contributes K GPU blades. When a failed GPU blade needs to be repaired or replaced, it can be replaced without interrupting the other GPU blades in the rack (i.e., live repair), thereby allowing the job to keep running while simultaneously repairing the device. As long as there are at least K operational blades in all the racks, then the job can continue to run. If any of the racks drops below K operational blades after having exhausted its spares, then the job halts.

To determine the MTTF, this may be modeled as 2M independent queues, each representing the number of failed GPU blades in a rack. As GPU blades fail, the blades are added to their respective queue; as they are repaired, they are removed from the queue. If the queue length exceeds the number of spares P in any of the 2M queues, then there are insufficient resources, and the job stops. From Appendix C, the MTTF of the intra-pod scheme with P standby spare blades that are powered on per rack is

$$M T T {F}_{intra - p o d} = \frac{M T T {F}_{D}}{2 \cdot M} \cdot {\sum }_{k = 0}^{P} {\sum }_{m = 0}^{{(}_{k + 1}^{P + 1} )} \frac{{γ}^{k}}{{\prod }_{n = 0}^{k} {\{ K , ( K + 1 ) … , ( K + P ) \}}_{m , n}^{k + 1}} \qquad ( 3 )$$

where

$${\{ \}}_{i , k}^{j}$$

is the k^{th} element of the i^{th} unique combination of j elements from the set. The failure rate driving the queue expansion in each of the 2M queues is that of the composite failure rate of GPU blades in the rack which can be seen in (3) by the attenuation by powers of K, the number of GPU blades in a rack.

For sparing efficiency, the efficiency ψ of each of the methods may be defined as the ratio of spare GPUs needed to meet the target MTTF to the number of operational GPUs the job requires (i.e., job size). For intra-pod and inter-pod, respectively:

$${ψ}_{intra - p o d} = \frac{M \cdot 2 \cdot P}{M \cdot 2 \cdot K} = \frac{P}{K} \qquad ( 4 )$$

$${ψ}_{inter - p o d} = \frac{R \cdot 2 \cdot K}{M \cdot 2 \cdot K} = \frac{R}{M} \qquad ( 5 )$$

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments may be practiced without these specific details. In other instances, well known structures and devices are shown in block diagram form in order to facilitate a description thereof. The intention is to cover all modifications, equivalents, and alternatives consistent with the claimed subject matter.

### Example System Architecture

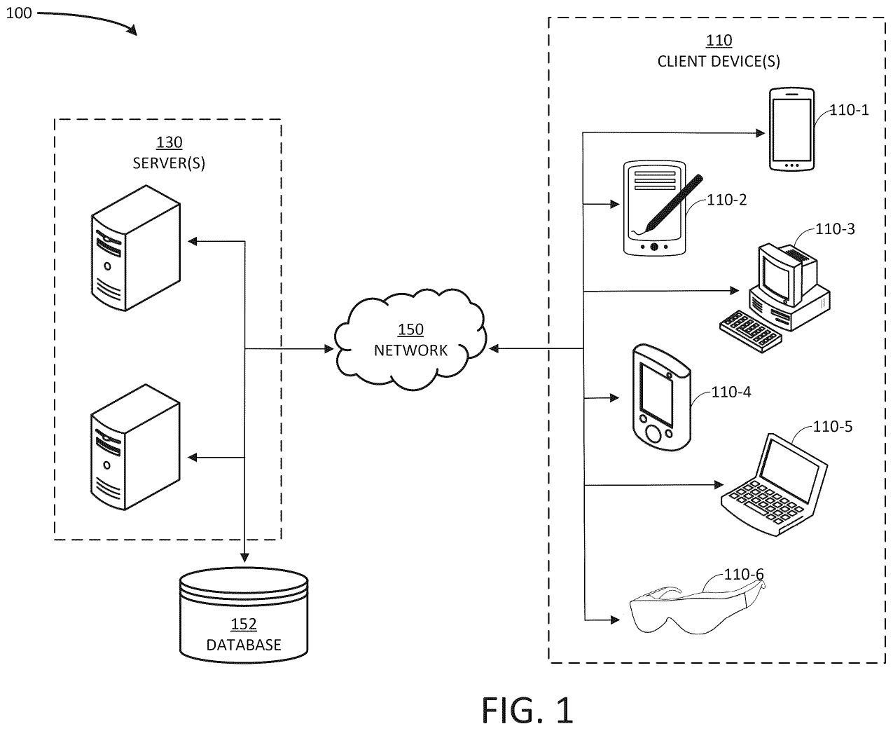

FIG. 1 illustrates an example environment 100 suitable for allocating system resources, according to some embodiments. Environment 100 may include server(s) 130 communicatively coupled with client device(s) 110 and database 152 over a network 150. One of the server(s) 130 may be configured to host a memory including instructions which, when executed by a processor, cause server(s) 130 to perform at least some of the steps in methods as disclosed herein. In some embodiments, the processor may be configured to control a graphical user interface (GUI) for the user of one of client device(s) 110 accessing an initial subset determining module, a maintenance metric determining module, a runtime determining module, an additional subset determining module, a subset comparing module, or a subset allocating module (e.g., initial subset determining module 240, maintenance metric determining module 242, runtime determining module 244, additional subset determining module 246, subset comparing module 248, or subset allocating module 250). For purposes of load balancing, multiple servers of server(s) 130 may host memories including instructions to one or more processors, and multiple servers of server(s) 130 may host a history log and database 152 including multiple training archives for the initial subset determining module, the maintenance metric determining module, the runtime determining module, the additional subset determining module, the subset comparing module, or the subset allocating module. Moreover, in some embodiments, multiple users of client device(s) 110 may access the same initial subset determining module, maintenance metric determining module, runtime determining module, additional subset determining module, subset comparing module, or subset allocating module. In some embodiments, a single user with a single client device (e.g., one of client device(s) 110) may provide data (e.g., images or text) to train one or more artificial intelligence (AI) models running in parallel in one or more server(s) 130. Accordingly, client device(s) 110 and server(s) 130 may communicate with each other via network 150 and resources located therein, such as data in database 152.

Server(s) 130 may include any device having an appropriate processor, memory, and communications capability for the initial subset determining module, the maintenance metric determining module, the runtime determining module, the additional subset determining module, the subset comparing module, or the subset allocating module. Any of the initial subset determining module, the maintenance metric determining module, the runtime determining module, the additional subset determining module, the subset comparing module, or the subset allocating module may be accessible by client device(s) 110 over network 150.

Client device(s) 110 may include any one of a laptop computer 110-5, a desktop computer 110-3, or a mobile device, such as a smartphone 110-1, a palm device 110-4, or a tablet device 110-2. In some embodiments, client device(s) 110 may include a headset or other wearable device 110-6 (e.g., an extended reality headset or smart glass, including a virtual reality, augmented reality, or mixed reality headset or smart glass), such that at least one participant may be running an extended reality application installed therein.

Network 150 may include, for example, any one or more of a local area network (LAN), a wide area network (WAN), the Internet, and the like. Further, network 150 may include, but is not limited to, any one or more of the following network topologies, including a bus network, a star network, a ring network, a mesh network, a star-bus network, tree or hierarchical network, and the like.

A user may own or operate client device(s) 110 that may include a smartphone device 110-1 (e.g., an IPHONE® device, an ANDROID® device, a BLACKBERRY® device, or any other mobile computing device conforming to a smartphone form). Smartphone device 110-1 may be a cellular device capable of connecting to a network 150 via a cell system using cellular signals. In some embodiments and in some cases, smartphone device 110-1 may additionally or alternatively use Wi-Fi or other networking technologies to connect to network 150. Smartphone device 110-1 may execute a client, Web browser, or other local application to access server(s) 130.

A user may own or operate client device(s) 110 that may include a tablet device 110-2 (e.g., an IPAD® tablet device, an ANDROID® tablet device, a KINDLE FIRE® tablet device, or any other mobile computing device conforming to a tablet form). Tablet device 110-2 may be a Wi-Fi device capable of connecting to a network 150 via a Wi-Fi access point using Wi-Fi signals. In some embodiments and in some cases, tablet device 110-2 may additionally or alternatively use cellular or other networking technologies to connect to network 150. Tablet device 110-2 may execute a client, Web browser, or other local application to access server(s) 130.

The user may own or operate client device(s) 110 that may include a laptop computer 110-5 (e.g., a MAC OS® device, WINDOWS® device, LINUX® device, or other computer device running another operating system). Laptop computer 110-5 may be an Ethernet device capable of connecting to a network 150 via an Ethernet connection. In some embodiments and in some cases, laptop computer 110-5 may additionally or alternatively use cellular, Wi-Fi, or other networking technologies to connect to network 150. Laptop computer 110-5 may execute a client, Web browser, or other local application to access server(s) 130.

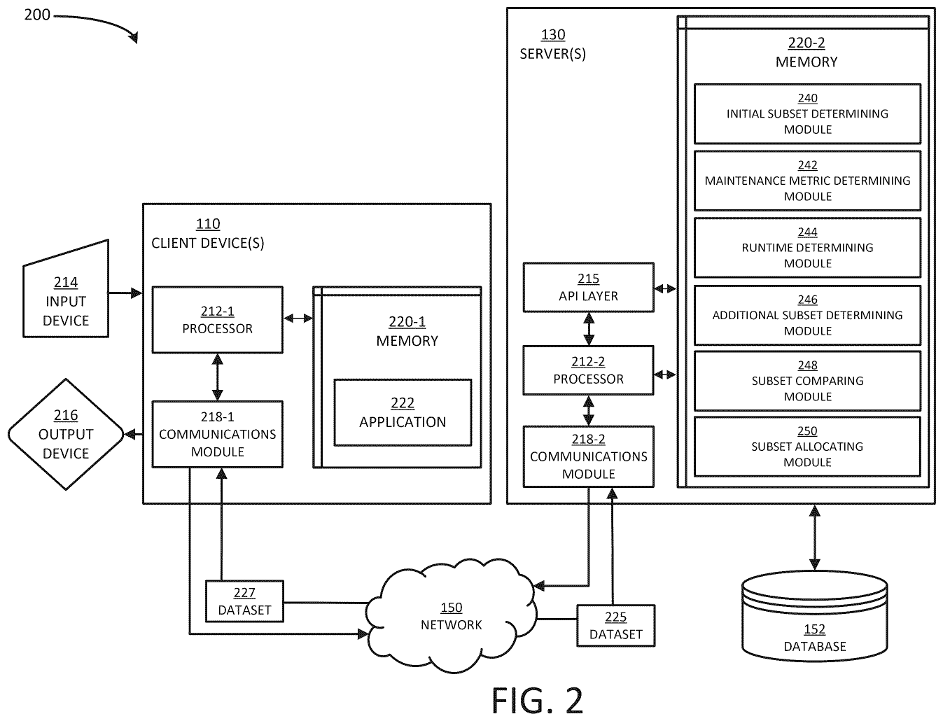

FIG. 2 is a block diagram 200 illustrating details of example client device(s) 110 and example server(s) 130 from the environment of FIG. 1, according to some embodiments. Client device(s) 110 and server(s) 130 may be communicatively coupled over network 150 via respective communications modules 218-1 and 218-2 (hereinafter, collectively referred to as “communications modules 218”). Communications modules 218 may be configured to interface with network 150 to send and receive information, such as requests, responses, messages, and commands to other devices on the network in the form of datasets 225 and 227. Communications modules 218 may be, for example, modems or Ethernet cards, and may include radio hardware and software for wireless communications (e.g., via electromagnetic radiation, such as radiofrequency (RF), near field communications (NFC), Wi-Fi, or Bluetooth radio technology). Client device(s) 110 may be coupled with input device 214 and with output device 216. Input device 214 may include a keyboard, a mouse, a pointer, a touchscreen, a microphone, a joystick, a virtual joystick, and the like. In some embodiments, input device 214 may include cameras, microphones, and sensors, such as touch sensors, acoustic sensors, inertial motion units (IMUs), and other sensors configured to provide input data to an AR/VR headset. For example, in some embodiments, input device 214 may include an eye-tracking device to detect the position of a pupil of a user in an AR/VR headset. Likewise, output device 216 may include a display and a speaker with which the user may retrieve results from client device(s) 110. Client device(s) 110 may also include processor 212-1, configured to execute instructions stored in memory 220-1, and to cause client device(s) 110 to perform at least some of the steps in methods consistent with the present disclosure. Memory 220-1 may further include application 222 configured to run in client device(s) 110 and couple with input device 214 and output device 216. Application 222 may be downloaded by the user from server(s) 130 or may be hosted by server(s) 130. In some embodiments, client device(s) 110 may be an AR/VR headset and application 222 may be an extended reality application. In some embodiments, client device(s) 110 may be a mobile phone used to collect a video or picture and upload to server(s) 130 using a video or image collection application (e.g., application 222), to store in database 152. In some embodiments, application 222 may run on any operating system (OS) installed in client device(s) 110. In some embodiments, application 222 may run out of a Web browser, installed in client device(s) 110.

Dataset 227 may include multiple messages and multimedia files. A user of client device(s) 110 may store at least some of the messages and data content in dataset 227 in memory 220-1. In some embodiments, a user may upload, with client device(s) 110, dataset 225 onto server(s) 130. Database 152 may store data and files associated with application 222 (e.g., one or more of datasets 225 and 227).

Server(s) 130 may include application programming interface (API) layer 215, which may control application 222 in each of client device(s) 110. Server(s) 130 may also include a memory 220-2 storing instructions which, when executed by processor 212-2, cause server(s) 130 to perform at least partially one or more operations in methods consistent with the present disclosure.

Processors 212-1 and 212-2 and memories 220-1 and 220-2 will be collectively referred to, hereinafter, as “processors 212” and “memories 220,” respectively.

Processors 212 may be configured to execute instructions stored in memories 220. In some embodiments, memory 220-2 may include initial subset determining module 240, maintenance metric determining module 242, runtime determining module 244, additional subset determining module 246, subset comparing module 248, or subset allocating module 250. Initial subset determining module 240, maintenance metric determining module 242, runtime determining module 244, additional subset determining module 246, subset comparing module 248, or subset allocating module 250 may share or provide features or resources to application 222. A user may access initial subset determining module 240, maintenance metric determining module 242, runtime determining module 244, additional subset determining module 246, subset comparing module 248, or subset allocating module 250 through application 222, installed in a memory 220-1 of client device(s) 110. Accordingly, application 222 may be installed by server(s) 130 and perform scripts and other routines provided by server(s) 130 through any one of multiple tools. Execution of application 222 may be controlled by processor 212-1.

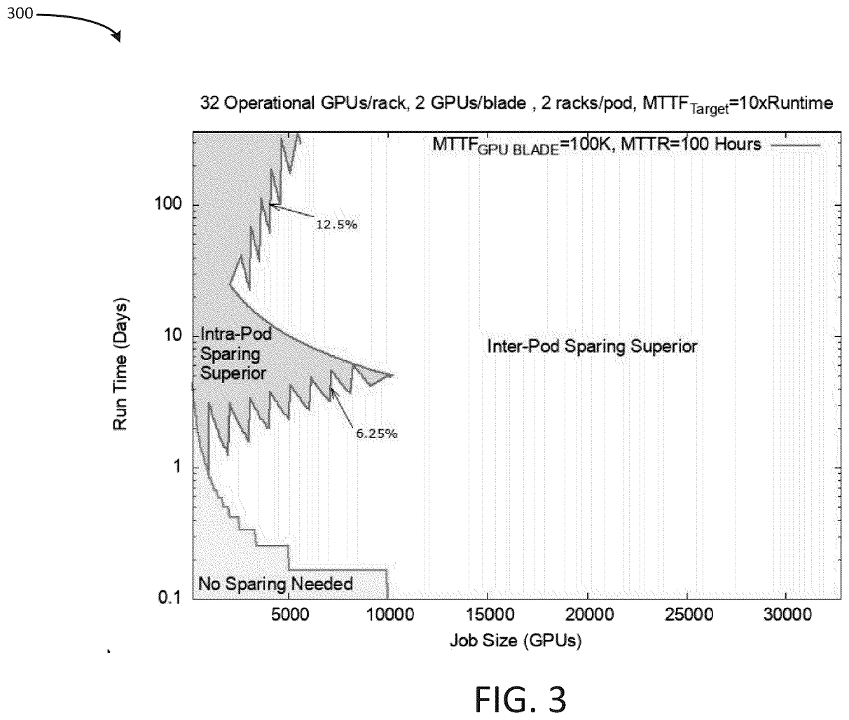

FIG. 3 includes a chart 300 illustrating an example curve representing the relationship between job size and job duration where inter-pod sparing and intra-pod sparing use an equal number of spare system resources, according to some embodiments. The following configuration is assumed: each rack contributes 32 GPUs to the workload and is composed of compute blades with 2 GPUs (i.e., K=16); and the ratio of the mean GPU blade failure time to mean repair time is set to 1000 (e.g., a 100 K hour MTTF_{D}, and a 100 hour MTTR).

In FIG. 3, the example curve is shown to create regions where no sparing is required (yellow region), where intra-pod sparing is superior (blue region), and where inter-pod sparing is superior (green region). From FIG. 3, the following may be noted:
(i) for larger jobs, inter-pod sparing is superior;
(ii) for jobs with short durations (less than one day), inter-pod sparing is superior as it can also encompass the region where no sparing is needed;
(iii) for small (less than 2 K GPUs) multi-day jobs, intra-pod sparing is superior; and
(iv) for medium multi-day jobs (2 K to 8 K), there are regions that require around 6.25% and 12.25% sparing where intra-pod sparing is superior. However, these regions diminish as the job size grows.

Where intra-pod sparing is superior it is due to the fact that adding a spare pod is a large percentage of sparing compared to adding a spare GPU blade. The saw-tooth region boundaries are due to the job size getting bigger transitioning to another step in inter-pod spares but keeping the same amount of intra-pod spares. The additional inter-pod sparing allows longer runtimes which are then degraded as the size increases until the next increase in spare pods. The smooth transition from intra-pod to inter-pod (c.f., from inter-pod to intra-pod) is due to the large steps between sparing levels in intra-pod so there are no abrupt transitions.

As the job size increases, inter-pod sparing benefits from the following:
(i) for the same percentage of sparing, larger jobs have a longer spares queue that offsets the higher failure rates from job-level protection than the smaller pod-level protection failure rates that drive the intra-pod sparing queues;
(ii) the amount of sparing can be tuned more precisely than intra-pod sparing, which is limited to jumps of one on the number of GPU blades contributing to a job in a rack (e.g., 6.25%, 12.5%, etc.).

For small or medium multi-day jobs:
(i) Adding a spare pod is a large percentage of sparing compared to adding a spare GPU blade favoring Intra-Pod.
(ii) When the required sparing is around 6.25% or 12.5%, intra-pod sparing has the advantage as inter-pod only has marginal gains from the longer queue and finer quantization. This advantage diminishes as the job size grows.

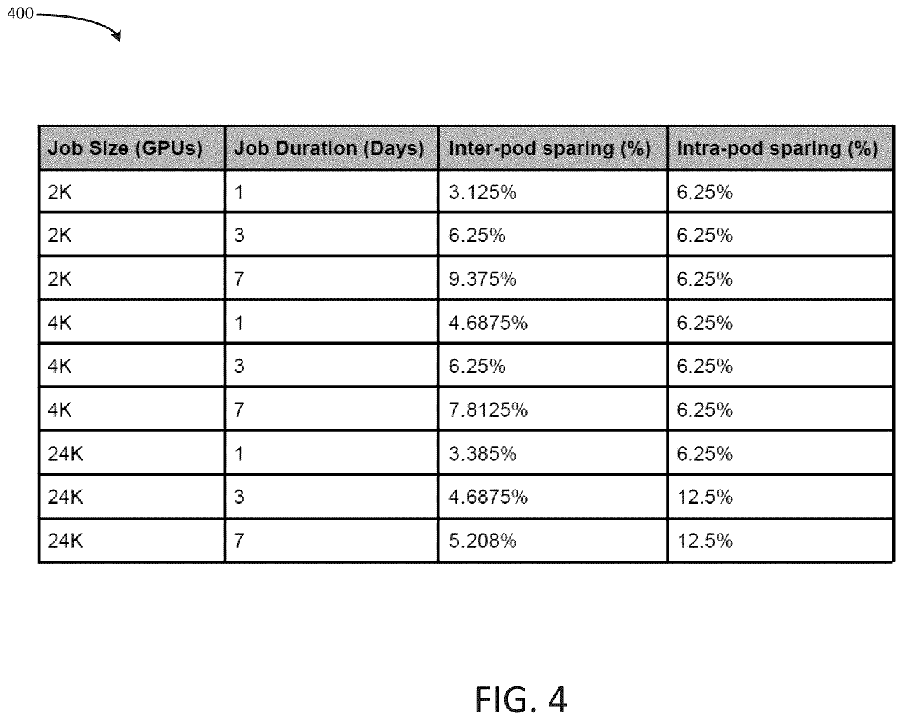

FIG. 4 is a table 400 showing the percentage of sparing required to meet the target job mean-time-to-failure (MTTF) for a collection of job sizes and durations as illustrated in FIG. 3, according to some embodiments. The same configuration is assumed for FIG. 4 as was assumed in FIG. 3. As may be noted from the table, for large jobs, the savings may be substantial (e.g., 2×). This may be primarily due to the long queue in inter-pod sparing more than offsetting the higher failure rates of the collection of GPU blades in the pods used by a job compared to the failure rates of GPU blades which drives shorter the intra-pod queue.

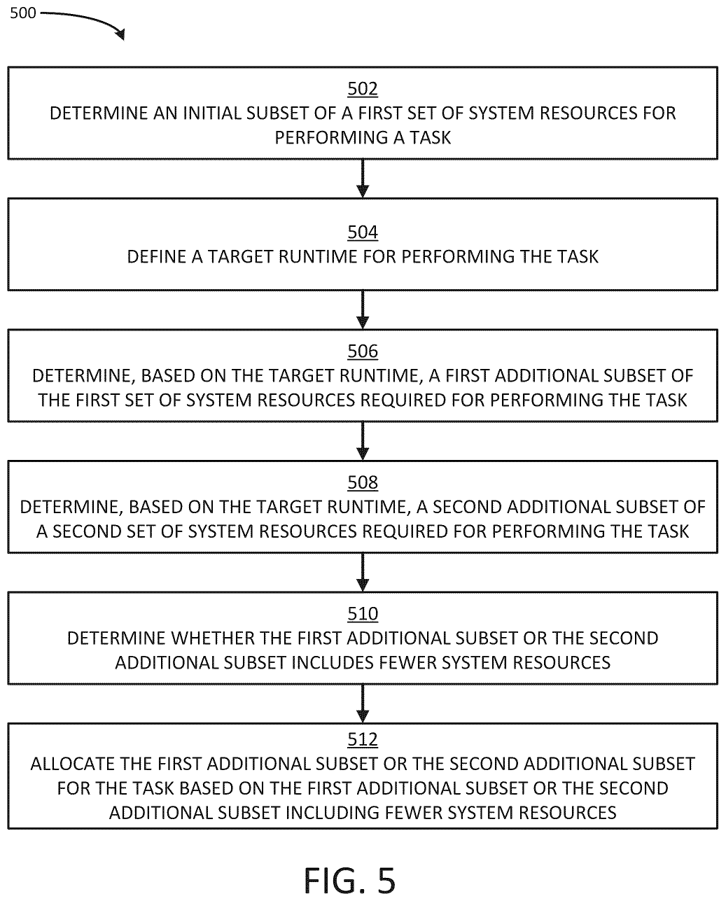

FIG. 5 is a flowchart illustrating operations in a method 500 for allocating system resources, according to some embodiments. In some embodiments, processes as disclosed herein may include one or more operations in method 500 performed by a processor circuit executing instructions stored in a memory circuit, in a client device, a remote server or a database, communicatively coupled through a network (e.g., processors 212, memories 220, client device(s) 110, server(s) 130, database 152, and network 150). In some embodiments, one or more of the operations in method 500 may be performed by an initial subset determining module, a maintenance metric determining module, a runtime determining module, an additional subset determining module, a subset comparing module, or a subset allocating module (e.g., initial subset determining module 240, maintenance metric determining module 242, runtime determining module 244, additional subset determining module 246, subset comparing module 248, subset allocating module 250). In some embodiments, processes consistent with the present disclosure may include at least one or more operations as in method 500 performed in a different order, simultaneously, quasi-simultaneously, or overlapping in time.

Operation 502 may include determining an initial subset of a first set of system resources for performing a task. In some embodiments, the first set of system resources may include a first plurality of graphics processing units (GPUs). In some embodiments, the task may include training an artificial intelligence (AI) model.

Operation 504 may include defining a target runtime for performing a task.

Operation 506 may include determining, based on the target runtime, a first additional subset of the first set of system resources required for performing a task. In some embodiments, determining the first additional subset of the first set of system resources may include determining the first additional subset of the first set of system resources required for performing the task when the initial subset of system resources is exhausted. In further aspects of the embodiments, operation 506 may include determining a maintenance metric for at least one of the first set of system resources and the second set of system resources. In some embodiments, the maintenance metric may include a mean-time-to-failure (MTTF) metric. In some embodiments, determining the first additional subset may include determining, based on the maintenance metric, the first set of system resources required for performing the task. In some embodiments, determining the second additional subset may include determining, based on the maintenance metric, the second set of system resources required for performing the task.

Operation 508 may include determining, based on a target runtime, a second additional subset of a second set of system resources required for performing a task. In some embodiments, the second set of system resources may include a second plurality of graphics processing units (GPUs). In some embodiments, determining the second additional subset of the second set of system resources may include determining the second additional subset of the second set of system resources required for performing the task when the initial subset of system resources is exhausted.

Operation 510 may include determining whether a first additional subset or a second additional subset includes fewer system resources.

Operation 512 may include allocating a first additional subset or a second additional subset for a task based on the first additional subset or the second additional subset including fewer system resources.

### Hardware Overview

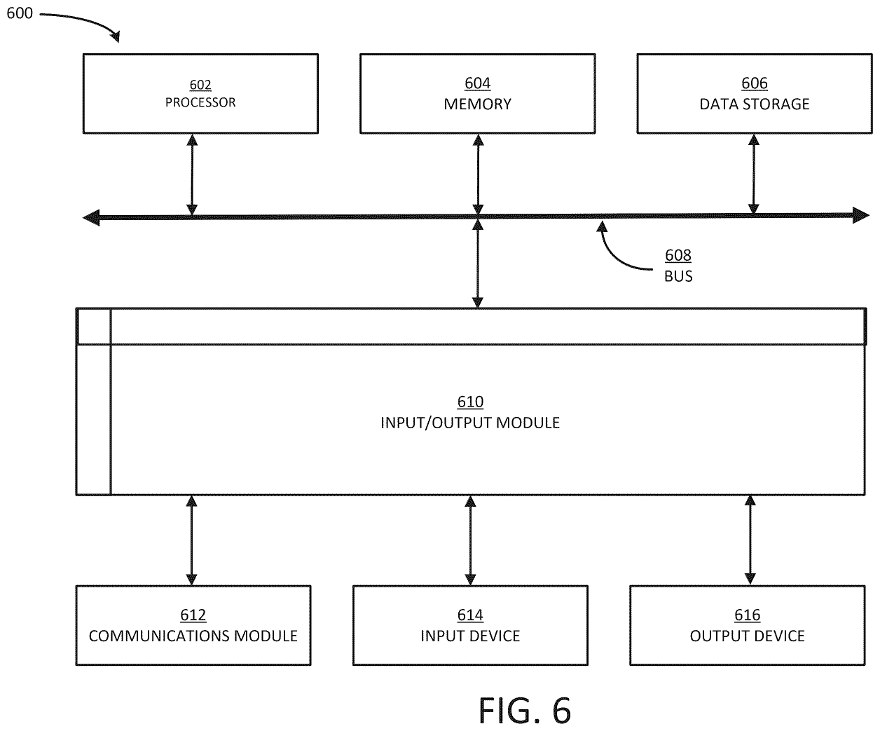

FIG. 6 is a block diagram illustrating an exemplary computer system 600 with which client devices, and the method in FIG. 5, may be implemented, according to some embodiments. In certain aspects, the computer system 600 may be implemented using hardware or a combination of software and hardware, either in a dedicated server, or integrated into another entity, or distributed across multiple entities.

Computer system 600 (e.g., client device(s) 110 and server(s) 130) may include bus 608 or another communication mechanism for communicating information, and a processor 602 (e.g., processors 212) coupled with bus 608 for processing information. By way of example, computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 600 may include, in addition to hardware, code that creates an execution environment for the computer program in question, e.g., code that constitutes processor firmware, a protocol stack, a database management system, an operating system, or a combination of one or more of them stored in an included memory 604 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. Processor 602 and the memory 604 may be supplemented by, or incorporated in, special purpose logic circuitry.

The instructions may be stored in memory 604 and implemented in one or more computer program products, e.g., one or more modules of computer program instructions encoded on a computer-readable medium for execution by, or to control the operation of, computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that may be located at one site or distributed across multiple sites and interconnected by a communication network. The processes and logic flows described in this specification may be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. Input/output module 610 may be any input/output module. Exemplary input/output modules 610 include data ports such as Universal Serial Bus (USB) ports. The input/output module 610 may be configured to connect to a communications module 612. Exemplary communications modules 612 (e.g., communications modules 218) include networking interface cards, such as Ethernet cards and modems. In certain aspects, input/output module 610 may be configured to connect to a plurality of devices, such as an input device 614 (e.g., input device 214) and/or an output device 616 (e.g., output device 216). Exemplary input devices 614 include a keyboard and a pointing device, e.g., a mouse or a trackball, by which a user may provide input to computer system 600. Other kinds of input devices 614 may be used to provide for interaction with a user as well, such as a tactile input device, visual input device, audio input device, or brain-computer interface device. For example, feedback provided to the user may be any form of sensory feedback, e.g., visual feedback, auditory feedback, or tactile feedback; and input from the user may be received in any form, including acoustic, speech, tactile, or brain wave input. Exemplary output devices 616 include display devices, such as an LCD (liquid crystal display) monitor, for displaying information to the user.

According to one aspect of the present disclosure, client device(s) 110 and server(s) 130 may be implemented using computer system 600 in response to processor 602 executing one or more sequences of one or more instructions contained in memory 604. Such instructions may be read into memory 604 from another machine-readable medium, such as data storage device 606. Execution of the sequences of instructions contained in memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, e.g., a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. The communication network (e.g., network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules may be, for example, modems or Ethernet cards.

Computer system 600 may include clients and servers. A client and server may be generally remote from each other and typically interact through a communication network. The relationship of client and server arises by virtue of computer programs running on the respective computers and having a client-server relationship to each other. Computer system 600 may be, for example, and without limitation, a desktop computer, laptop computer, or tablet computer. Computer system 600 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires forming bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

Although illustrative embodiments have been shown and described, a wide range of modification, change, and substitution are contemplated in the foregoing disclosure and in some instances, some features of the embodiments may be employed without a corresponding use of other features. Those of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A computer-implemented method, comprising:
determining an initial subset of a first set of system resources for performing a task;
defining a target runtime for performing the task;
determining, based on the target runtime, a first additional subset of the first set of system resources required for performing the task;
determining, based on the target runtime, a second additional subset of a second set of system resources required for performing the task;
determining whether the first additional subset or the second additional subset includes fewer system resources; and
allocating the first additional subset or the second additional subset for the task based on the first additional subset or the second additional subset including fewer system resources.

2. The computer-implemented method of claim 1, wherein the first set of system resources includes a first plurality of graphics processing units (GPUs).

3. The computer-implemented method of claim 1, wherein the second set of system resources includes a second plurality of graphics processing units (GPUs).

4. The computer-implemented method of claim 1, wherein the task includes training an artificial intelligence (AI) model.

5. The computer-implemented method of claim 1, wherein determining the first additional subset of the first set of system resources includes determining the first additional subset of the first set of system resources required for performing the task when the initial subset of system resources is exhausted.

6. The computer-implemented method of claim 1, wherein determining the second additional subset of the second set of system resources includes determining the second additional subset of the second set of system resources required for performing the task when the initial subset of system resources is exhausted.

7. The computer-implemented method of claim 1, further including determining a maintenance metric for at least one of the first set of system resources and the second set of system resources.

8. The computer-implemented method of claim 7, wherein the maintenance metric includes a mean-time-to-failure (MTTF) metric.

9. The computer-implemented method of claim 7, wherein determining the first additional subset includes determining, based on the maintenance metric, the first set of system resources required for performing the task.

10. The computer-implemented method of claim 7, wherein determining the second additional subset includes determining, based on the maintenance metric, the second set of system resources required for performing the task.

11. A system, comprising:
one or more processors; and
a memory storing instructions that, when executed by the one or more processors, cause the system to perform operations including:
determining an initial subset of a first set of system resources for performing a task;
defining a target runtime for performing the task;
determining, based on the target runtime, a first additional subset of the first set of system resources required for performing the task;
determining, based on the target runtime, a second additional subset of a second set of system resources required for performing the task;
determining whether the first additional subset or the second additional subset includes fewer system resources; and
allocating the first additional subset or the second additional subset for the task based on the first additional subset or the second additional subset including fewer system resources.

12. The system of claim 11, wherein the first set of system resources includes a first plurality of graphics processing units (GPUs).

13. The system of claim 11, wherein the second set of system resources includes a second plurality of graphics processing units (GPUs).

14. The system of claim 11, wherein the task includes training an artificial intelligence (AI) model.

15. The system of claim 11, wherein determining the first additional subset of the first set of system resources includes determining the first additional subset of the first set of system resources required for performing the task when the initial subset of system resources is exhausted.

16. The system of claim 11, wherein determining the second additional subset of the second set of system resources includes determining the second additional subset of the second set of system resources required for performing the task when the initial subset of system resources is exhausted.

17. The system of claim 11, further including determining a maintenance metric for at least one of the first set of system resources and the second set of system resources.

18. The system of claim 17, wherein the maintenance metric includes a mean-time-to-failure (MTTF) metric.

19. The system of claim 17, wherein:
determining the first additional subset includes determining, based on the maintenance metric, the first set of system resources required for performing the task; and
determining the second additional subset includes determining, based on the maintenance metric, the second set of system resources required for performing the task.

20. A non-transitory computer-readable storage medium storing instructions encoded thereon that, when executed by a processor, cause the processor to perform operations comprising:
determining an initial subset of a first set of system resources for performing a task, wherein the first set of system resources includes a first plurality of graphics processing units (GPUs), and wherein the task includes training an artificial intelligence (AI) model;
defining a target runtime for performing the task;
determining a maintenance metric for at least one of the first set of system resources and a second set of system resources;
determining, based on the target runtime and the maintenance metric, a first additional subset of the first set of system resources required for performing the task when the initial subset of system resources is exhausted;
determining, based on the target runtime and the maintenance metric, a second additional subset of the second set of system resources required for performing the task when the initial subset of system resources is exhausted, wherein the second set of system resources includes a second plurality of graphics processing units (GPUs);
determining whether the first additional subset or the second additional subset includes fewer system resources; and
allocating the first additional subset or the second additional subset for the task based on the first additional subset or the second additional subset including fewer system resources.
